(19) United States
(12) Patent Application Publication
(10) Pub. No.: US 2007/0234708 A1
(43) Pub. Date: Oct. 11, 2007

(54) Method of on-board diagnostic catalyst monitoring

(76) Inventors: James Peyton Jones, Swarthmore, PA (US); Kenneth R. Muske, Berwyn, PA (US)

Correspondence Address: STRADLEY RONON STEVENS & YOUNG, LLP, 30 VALLEY STREAM PARKWAY, GREAT VALLEY CORPORATE CENTER, MALVERN, PA, 19355-1481, US

(21) Appl. No.: 11/784,289

(22) Filed: Apr. 6, 2007

Related U.S. Application Data
(60) Provisional application No. 60/790,230, filed on Apr. 6, 2006.

(51) Int. Cl. G01M 19/00; F01N 3/00; F01N 7/00

(52) U.S. Cl. 60/277; 60/276; 73/118.1

(57) ABSTRACT

A method of on-board diagnostic (OBD) catalyst monitoring. Vehicle OBD exhaust systems often include a catalyst, a pre-catalyst exhaust gas oxygen sensor, and a post-catalyst exhaust gas oxygen sensor. A method is provided of monitoring the catalyst which includes the steps of measuring hydrogen or nitrogen dioxide generation by the catalyst, and correlating changes in hydrogen or nitrogen dioxide generation to changes in catalytic conversion efficiency. Because OBD legislation defines catalyst deterioration or malfunction in terms of hydrocarbon or nitrogen oxide emission levels, the method uses hydrogen or nitrogen dioxide generation as a metric for OBD monitoring of the catalyst and offers the advantage of a more direct relationship to catalyst health than conventional methods.

### RELATED APPLICATION

This application claims the benefit of priority to U.S. Provisional Patent Application Ser. No. 60/790,230, filed on Apr. 6, 2006, the contents of which are incorporated in this application by reference.

### GOVERNMENT RIGHTS

The present invention was made with government support under grant CTS-0215920 awarded by the National Science Foundation. The government has certain rights in the invention.

### TECHNICAL FIELD

The present invention relates generally to vehicle-related air pollution and, more particularly, to on-board diagnosis of catalyst deterioration or malfunction in terms of hydrocarbon and nitrogen oxide emission levels.

### BACKGROUND OF THE INVENTION

A catalytic converter is a device that uses a catalyst to convert harmful compounds in automobile (and, more generally, motor vehicle) exhaust into harmless compounds. Three harmful compounds are hydrocarbon (HC) such as C₃H₈ and CH₄ in the form of unburned gasoline, carbon monoxide (CO) formed by the incomplete combustion of gasoline, and nitrogen oxides (NOₓ) created when the heat in the engine forces nitrogen in the air to combine with oxygen. HC produces smog, carbon monoxide is a poison for any air-breathing animal, and nitrogen oxides lead to smog and acid rain.

In a catalytic converter, the catalyst (in the form of platinum and palladium) is coated onto a ceramic honeycomb or ceramic beads that are housed in a muffler-like package attached to the exhaust pipe. The catalyst converts the HC into carbon dioxide and water, helps to convert carbon monoxide into carbon dioxide, and converts the nitrogen oxides back into nitrogen and oxygen.

Motor vehicle manufacturers are required by legislation to provide on-board monitors of the efficacy of vehicle exhaust after-treatment systems (e.g., the catalyst). The problem is that conversion efficiency cannot be measured directly; the efficiency must be inferred in some way. The legislation aimed at reducing vehicle-related air pollution through on-board diagnostic (OBD) systems defines catalyst deterioration or malfunction in terms of HC and NOₓ emissions levels. This definition makes catalyst OBD a very challenging task because HC and NOₓ are difficult to measure directly in-vehicle. Therefore, OBD systems must rely on the correlation between HC emissions and some more readily measurable quantity. A number of systems exploit the catalyst exotherm for this purpose, but the majority of practical applications use some measure of oxygen storage capacity as the primary diagnostic metric.

Although it is clear that oxygen storage dynamics have a strong influence on catalyst conversion efficiency, the correlation of oxygen storage capacity with age is far from perfect. See J. Hepburn & H. Gandhi, The Relationship Between Catalyst Hydrocarbon Conversion Efficiency and Oxygen Storage Capacity, SAE paper 920831 (1992). The use of oxygen storage capacity metrics is widespread partly for lack of a better alternative, and partly because the method uses pre- and post-catalyst exhaust gas oxygen (EGO) sensors which are often already in place as part of the emissions control system. It should be noted, however, that these sensors are not ideal. Indeed their sensitivity to changing concentrations of hydrogen (particularly in the post-catalyst exhaust) can distort the oxygen storage and release effects they are intended to measure. See J. Peyton Jones & R. Jackson, Potential & Pitfalls in the Use of Dual EGO Sensors for 3-Way Catalyst Monitoring & Control, Proceedings of the Institute of Mechanical Engineers, Part D: Journal of Automobile Engineering, vol. 217, pp. 475-88 (2003) (this article is incorporated in the present document by reference) (hereinafter J. Peyton Jones & R. Jackson, Potential & Pitfalls).

There remains a need, therefore, for an improved method of OBD catalyst monitoring.

### BRIEF SUMMARY OF THE INVENTION

To meet this and other needs, and in view of its purposes, the present invention provides a method of OBD catalyst monitoring. Vehicle OBD exhaust systems often include a catalyst, a pre-catalyst exhaust gas oxygen sensor, and a post-catalyst exhaust gas oxygen sensor. A method is provided of monitoring the catalyst which includes the steps of measuring hydrogen generation by the catalyst, and correlating changes in hydrogen generation to changes in hydrocarbon or NOₓ conversion efficiency. The hydrogen generation by the catalyst may be measured, among other ways, as a function of post-catalyst exhaust gas oxygen sensor distortion. Because OBD legislation defines catalyst deterioration or malfunction in terms of hydrocarbon and NOₓ emission levels, the method uses hydrogen generation as a metric for OBD monitoring of the catalyst and offers the advantage of a more direct relationship to catalyst health than conventional methods.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. Included in the drawing are the following figures:

FIG. 1 is a graph of air-fuel ratio (AFR) versus time, illustrating catalyst response to a step change in pre-catalyst AFR;

FIG. 2A is a graph of CO (vol %) versus time, illustrating catalyst response to a step change in the amount of pre-catalyst CO;

FIG. 2B is a graph of hydrocarbon (ppm) versus time, illustrating catalyst response to a step change in the amount of pre-catalyst hydrocarbon;

FIG. 2C is a graph of NO (ppm) versus time, illustrating catalyst response to a step change in the amount of pre-catalyst NO;

FIG. 3 is a graph of hydrocarbon (HC) conversion efficiency (% η_{HC}) versus (Δλₚᵣₑ-Δλₚₒₛₜ), illustrating the correlation between (Δλₚᵣₑ-Δλₚₒₛₜ) and HC conversion efficiency during reversible deactivation (Zone C in FIG. 1);

FIG. 4A is a graph of NO (ppm) versus time, illustrating the comparative response of two differently aged catalysts to ±3% step changes in feed gas (pre-catalyst) AFR (1500 rpm low load);

FIG. 4B is a graph of HC (ppm Cl) versus time, illustrating the comparative response of two differently aged catalysts to ±3% step changes in feed gas (pre-catalyst) AFR (1500 rpm low load);

FIG. 4C is a graph of CO (%) versus time, illustrating the comparative response of two differently aged catalysts to ±3% step changes in feed gas (pre-catalyst) AFR (1500 rpm low load);

FIG. 4D is a graph of CO₂ (%) versus time, illustrating the comparative response of two differently aged catalysts to ±3% step changes in feed gas (pre-catalyst) AFR (1500 rpm low load);

FIG. 4E is a graph of O₂ (%) versus time, illustrating the comparative response of two differently aged catalysts to ±3% step changes in feed gas (pre-catalyst) AFR (1500 rpm low load);

FIG. 4F is a graph of H₂ (%) versus time, illustrating the comparative response of two differently aged catalysts to ±3% step changes in feed gas (pre-catalyst) AFR (1500 rpm low load);

FIG. 4G is a graph of λ_{wide} (−) versus time, illustrating the comparative response of two differently aged catalysts to ±3% step changes in feed gas (pre-catalyst) AFR (1500 rpm low load); and

FIG. 4H is a graph of λ_{switch} (V) versus time, illustrating the comparative response of two differently aged catalysts to ±3% step changes in feed gas (pre-catalyst) AFR (1500 rpm low load).

### DETAILED DESCRIPTION OF THE INVENTION

Pre- and post-catalyst exhaust gas oxygen (EGO) sensors are traditionally used to monitor oxygen storage capacity for on-board diagnostic (OBD) purposes. The present invention uses the same sensors instead to monitor catalyst-promoted hydrogen generation, exploiting the sensors' otherwise undesirable sensitivity to the hydrogen content in the exhaust. This approach to catalyst health diagnosis has advantages because hydrogen generation and hydrocarbon (HC) conversion efficiency both depend on the degree of activation (or deactivation) of the catalyst surface, and are therefore strongly correlated to each other. One advantage of the approach is that it is more directly related to catalyst deterioration or malfunction as defined (in terms of HC emissions levels) under current OBD legislation.

Sensor distortion is generally undesirable because it degrades the performance of catalyst control and OBD strategies. The present invention exploits sensor distortion, however, as a measure of catalyst age. Recent work has demonstrated, for example, that sensor distortion can be used as a measure of hydrogen production by the catalyst, and that hydrogen production is also strongly correlated to HC conversion efficiency. See J. Peyton Jones, R. Jackson, & J. Roberts, The Importance Of Reversible Deactivation Dynamics For On-Board Catalyst Control And OBD Systems, SAE 2002 Transactions, Section 4: Journal of Fuels & Lubricants, pp. 76-84, also SAE paper 2002-01-0067 (2002) (this article is incorporated in the present document by reference). Therefore, sensor distortion is an ideal metric for OBD purposes.

The mechanisms behind the observed correlation between sensor distortion with catalyst age are readily apparent, because the hydrogen-generating water gas shift and steam reforming reactions and the HC conversion reactions are all influenced by the degree of catalyst surface activation or de-activation. The present invention demonstrates the feasibility of its approach using experimental data from a variety of differently aged catalysts.

### A. EGO SENSOR RESPONSE AND HYDROGEN

Currently vehicles are equipped with EGO sensors in order to measure the air-fuel ratio (AFR) represented by lambda, λ, which is AFR normalized with respect to stoichiometry. There are two main types of EGO sensors: narrow-band heated exhaust gas oxygen (HEGO) sensors which switch sharply at λ=1, and wide-band universal exhaust gas oxygen (UEGO) sensors which can measure over a wider range without saturating. In both cases, although they nominally measure the oxygen excess or deficiency in the exhaust (relative to the “perfect” stoichiometric mixture), these sensors also have cross-sensitivity to hydrogen. This cross-sensitivity is traditionally regarded as unwanted bias and distortion. The method of the present invention exploits the cross-sensitivity to convert existing sensors into combined hydrogen and oxygen sensors.

The behavior of EGO sensors was well documented in the early 1980's following their introduction in air-fuel ratio (AFR) control systems. See, e.g., M. Shulman & D. Hamburg, Non-ideal Properties of ZrO2 and TiO2 Exhaust Gas Oxygen Sensors, SAE paper 800018 (1980); E. Logothetis, Advances in Ceramics, vol. 3, p. 388 (A. Heuer & L. Hobbs eds., American Ceramic Society, 1981); A. Colvin, J. Butler, & J. Anderson, Catalytic Effects on ZrO2 Oxygen Sensors Exposed to Non-Equilibrium Gas Mixtures, J. Electroanal. Chem., vol. 136, pp. 179-83 (1982); and I. Murase, A. Moriyama, & M. Nakai, A Portable Fast Response Air-Fuel Ratio Meter Using an Extended Range Oxygen Sensor, SAE paper 880559 (1988). Although many of these early studies noted that the ideal sensor output was biased by preferential diffusion or non-equilibration effects, it was generally sufficient simply to calibrate the sensor for typical engine-out exhaust gas composition.

More recently, however, there has been a resurgence of interest in these effects. Such renewed interest is partly due to the degree of refinement now required of AFR control systems. See, e.g., J. Burglass, T. Morgan, & J. Graupner, Interactions Between Exhaust Gas Compositions and Oxygen Sensor Performance, SAE paper 982646 (1998), and G. Fiengo, J. Cook, & J. Grizzle, Fore-Aft Oxygen Storage Control, Proceedings of the American Control Conference (Anchorage, Ak., 2002). The renewed interest is also due to the use of EGO sensors downstream of the catalyst. See, e.g., J. Peyton Jones & R. Jackson, Potential & Pitfalls (mentioned above); H. Germann, S. Taglaiferri, & H. Geering, Differences in Pre- and Post Converter Lambda Sensor Characteristics, SAE paper 960335 (1996); T, Aukenthaler, C. Onder, & H. Geering, Modelling of a Solid-Electrolyte Oxygen Sensor, SAE paper 2002-01-1293 (2002); J. Peyton Jones & K. Muske, Model-based OBD for Three-Way Catalyst Systems, SAE paper 2004-01-0639 (2004) (hereinafter J. Peyton Jones and K. Muske, Model-based OBD); and T. Aukenthaler, C. Onder, & H. Geering, Aspects of Dynamic Three-Way-Catalytic Converter Behaviour Including Oxygen Storage, Proceedings of the Fourth IFAC International Symposium on Advances in Automotive Control, pp. 345-50 (Salerno, Italy, 2004) (hereinafter T. Aukenthaler et al., Aspects of Dynamic Three-Way-Catalytic Converter Behaviour).

In the post-catalyst application, the calibrations developed for engine-out exhaust are no longer valid because the gas composition is very different. Non-equilibration errors may be smaller as a result of catalyst action, but preferential diffusion of H₂ or NO₂, for example, can result in a significant bias. The bias is also time-varying because the concentrations of these gases depend on the dynamics of the reaction taking place on the catalyst brick. The resultant distortion of the sensor signal presents a significant challenge to catalyst control and OBD systems. See, e.g., M. Balenovic, A. Backx, & J. Hoebink, On a Model-based Control of a Three-way Catalytic Converter, SAE paper 2001-01-0937 (2001), and K. Muske & J. Peyton Jones, Model-Based Fault Detection for Three-Way Automotive Catalyst Systems, Proceedings of the Fourth IFAC International Symposium on Advances in Automotive Control, pp. 374-79 (Salerno, Italy, 2004) (hereinafter K. Muske and J. Peyton Jones, Model-based Fault Detection). The distortion also opens the possibility, however, of using the device as a hydrogen sensor (under rich conditions), or as an NO₂ sensor (under lean conditions). The mechanisms underlying such sensitivity are outlined below; further details may be found in J. Peyton Jones & R. Jackson, Potential & Pitfalls.

A wide-ranging or UEGO sensor is constructed from two zirconia electrolytic cells. The first cell is used to detect any departure from stoichiometry of the gas within the detection cavity. Any observed deviations are amplified and used to drive a current through the second cell, which then pumps oxygen either in to or out of the detection cavity until stoichiometry is restored. The pumping current, Iₚ, is therefore a direct measure of Δ\dot{ñ}ₒ_{₂}, the molar flow rate of oxygen required to maintain stoichiometry in the cavity, because by Faraday's law of electrolysis,

Iₚ=4FΔ\dot{ñ}ₒ_{₂} (Eqn. 1)

Assuming perfect equilibration, Δ\dot{ñ}ₒ_{₂} is also (by definition) equal to the oxygen excess or deficiency of the components entering the cell from the exhaust gas:

$$Δ {\tilde{\dot{n}}}_{{O}_{2}} = {\tilde{\dot{n}}}_{{O}_{2}} + {\tilde{\dot{n}}}_{{NO}_{2}} + 0.5 {\tilde{\dot{n}}}_{NO} - 0.5 {\tilde{\dot{n}}}_{CO} - 0.5 {\tilde{\dot{n}}}_{{H}_{2}} - ( x + y / 4 ) {\tilde{\dot{n}}}_{{C}_{x}} {H}_{y} \qquad ( Eqn . 2 )$$

It is important to note from Equations 1 and 2 that the current output reflects the oxygen pumped in or out of the cell, rather than the oxygen concentration (or even the equilibrium oxygen concentration) of the gas itself; negative pumping currents indicate oxygen deficiency or rich conditions, just as positive currents indicate oxygen excess. It is also important to note that the sensor responds to the composition of gas entering the cell (as indicated by the tilde notation in Equations 1 and 2) rather than the composition of the original exhaust. The two are not necessarily identical due to differences in the rate at which each gas component diffuses through the cell walls.

For any given gas component, X, flow rates into the cavity are related to the partial pressure or mole fraction of the surrounding gas according to,

$$\begin{matrix}{\tilde{\dot{n}}}_{x} = \frac{{AD}_{x}}{RTL} ( {P}_{x} - {\tilde{P}}_{x} ) \approx \frac{{AD}_{{O}_{2}}}{RTL} {D}_{x} {P}_{x} \\ = \frac{{AD}_{{O}_{2}}}{RTL} \frac{P}{{n}_{tot}} {D}_{x} {n}_{x}\end{matrix} \qquad ( Eqn . 3 )$$

where A and L signify the diffusion path cross-sectional area and length, respectively; Dₓ is the diffusion coefficient of gas X; and D_{O2} is the same diffusion coefficient normalized by the diffusion coefficient of oxygen. The second equality follows from the assumption that the partial pressure of X inside the cavity, \tilde{P}ₓ is zero once all the components have been perfectly equilibrated. The third equality simply expresses the partial pressure as a mole fraction, where P is the pressure and nₜₒₜ is the total moles (all molar quantities in this document are defined as per mole of fuel). By combining Equations 1, 2, and 3, the sensor output current, Iₚ, can be rewritten as:

$$\begin{matrix}{I}_{p} = {K}_{p} \frac{P}{{n}_{tot}} Δ {n}_{{O}_{2}}^{′} {K}_{p} = \frac{4 {FAD}_{{O}_{2}}}{RTL} \\ where , & ( Eqn . 4 ) \\ Δ {n}_{{O}_{2}}^{′} = {n}_{{O}_{2}} + {D}_{{NO}_{2}} {n}_{{NO}_{2}} + 0.5 {D}_{NO} {n}_{NO } - 0.5 {D}_{CO} {n}_{CO} - 0.5 {D}_{{H}_{2}} {n}_{{H}_{2}} - ( x + y / 4 ) {D}_{{C}_{x} {H}_{y}} {n}_{{C}_{x} {H}_{y}} & ( Eqn . 5 )\end{matrix}$$

Note that the amount of gas component X seen by the electrode depends not only on its level in the surrounding exhaust, but also on the normalized coefficient of diffusion, Dₓ, with which it diffuses through the porous sidewalls of the chamber. Gases that diffuse faster than oxygen (i.e., with a normalized diffusion coefficient greater than unity), are therefore relatively over-represented at the electrode, while the converse is true for gases that diffuse more slowly. The resulting bias in the sensor output can be seen more readily by rewriting Equation 4 as

$$\begin{matrix}{I}_{p} = {K}_{p} \frac{P}{{n}_{tot}} ( Δ {n}_{{O}_{2}} + {δ}_{λ} ( gas ) ) \\ = {K}_{p} \frac{P}{{n}_{tot}} ( {K}_{λ} Δ λ + {δ}_{λ} ( gas ) )\end{matrix} \qquad ( Eqn . 6 )$$

where Δn_{O2} (without the prime) denotes the true molar excess or deficiency of oxygen in the surrounding gas, where Δλ is the normalized AFR measured relative to stoichiometry and defined according to:

$$Δ λ = \frac{Δ {n}_{{O}_{2}}}{{K}_{λ}} {K}_{λ} = ( x + y / 4 ) \qquad ( Eqn . 7 )$$

and where δ_{λ}(gas) represents the bias due to preferential diffusion effects given by,

$$\begin{matrix}{δ}_{λ} ( gas ) = ( Δ {n}_{{O}_{2}}^{′} - Δ {n}_{{O}_{2}} ) \\ = ( \begin{matrix}( {D}_{{NO}_{2}} - 1 ) {n}_{{NO}_{2}} + 0.5 ( {D}_{NO} - 1 ) {n}_{NO} - \\ 0.5 ( {D}_{CO} - 1 ) {n}_{CO} - 0.5 ( {D}_{{H}_{2}} - 1 ) {n}_{{H}_{2}} - \\ ( x + y / 4 ) ( {D}_{{C}_{x} {H}_{y}} - 1 ) {n}_{{C}_{x} {H}_{y}}\end{matrix} )\end{matrix} \qquad ( Eqn . 8 )$$

In practice many of the terms in Equation 8 are negligible, either because the factor (Dₓ-1) vanishes for gases (such as CO or NO) whose normalized diffusion coefficient is close to unity, or (as in the case of unburned hydrocarbon) because the concentration of that component is relatively low in the exhaust. The bias due to hydrogen, however, is much more significant because hydrogen diffuses approximately four times faster than oxygen (D_{H2}≈4), and because significant quantities of hydrogen can be generated by the water-gas shift reaction under rich operating conditions. Similarly, under lean conditions the effect of NO₂ (for which D_{NO2}≈0.83) can also prove significant. Equation 8 may therefore be approximated by,

$${δ}_{λ} ( gas ) = \{ \begin{matrix}{K}_{p} ( {D}_{{NO}_{2}} - 1 ) {n}_{{NO}_{2}} \text{:} & lean \\ - 0.5 {K}_{p} ( {D}_{{H}_{2}} - 1 ) {n}_{{H}_{2}} \text{:} & rich\end{matrix} \qquad ( Eqn . 9 )$$

Inspection of Equations 6 and 9 shows that a UEGO sensor responds not only to the true oxygen excess or deficiency, but also to the amount of H₂ or NO₂ present in the gas mixture. As outlined below, this characteristic provides useful information about H₂ and NO₂ formation on the catalyst. Traditionally, however, these effects are undesirable and are removed using a calibration curve g(·), derived for model engine gas for which the concentrations of H₂ and NO₂ are known. An expression for g(·) can be obtained by rearranging Equation 6 to give,

$${Δλ}^{′} = g ( {I}_{p} , {δ}_{λ} ( gas ) ) = \frac{{n}_{tot} {I}_{p}}{{K}_{λ} {K}_{p} P} - \frac{{δ}_{λ} ( gas )}{{K}_{λ}} \qquad ( Eqn . 10 )$$

The accuracy of the indicated AFR, Δλ′, however, depends on the degree to which the operational gas matches the AFR assumed during calibration. In engine-out applications, this match is reasonably good and measurement errors are relatively small. In post-catalyst applications, however, not only is there a significant mismatch between actual gas composition and model exhaust, but the gas composition is not even a static function of AFR. It is therefore not possible to “calibrate out” the sensitivities to H₂ and NO₂, and there will be a measurement error, ε_{λ}(gas), between the true and observed AFR:

Δλ′=Δλ+ε_{λ}(gas) (Eqn. 11)

where from Equations 10 and 11, ε_{λ}(gas) may be written as,

ε_{λ}(gas)≈1/K_{λ}(δ_{λ}(gas)−δ_{λ}(model_gas)) (Eqn. 12)

Typically the sensor reads richer than true (i.e., ε_{λ}(gas) is negative) if the H₂ or NO₂ concentration is higher than that assumed during sensor calibration. In the same way, ε_{λ}(gas) will be positive when these concentrations are lower than in the model gas, causing the sensor to read leaner than it should. In practice, the post-catalyst gas composition changes dynamically with time, and the distortion term therefore cannot readily be distinguished from oxygen storage and release effects. Post-catalyst sensor distortion is therefore problematic for conventional catalyst control or OBD strategies, but it should not be forgotten that the distortion is a product of the reactions taking place on the brick, and that it therefore contains potentially useful information.

### B. DUAL EGO SENSORS AND REVERSIBLE CATALYST DEACTIVATION

Although catalyst conversion efficiency is ultimately the result of a series of highly complex and spatially distributed set of reactions, it is widely accepted that these reactions are dominated by the dynamics of oxygen storage and release from the ceria in the catalyst washcoat. The molar rate of oxygen storage, \dot{θ}, which defines these dynamics is also a function of the difference between pre-catalyst and post-catalyst AFR, because from Equation 7,

$$( {Δλ}_{pre} - {Δλ}_{post} ) = \frac{1}{{\dot{n}}_{f} {K}_{λ}} \dot{θ} \qquad ( Eqn . 13 )$$

where \dot{n}_{f} represents the molar flow rate of fuel. Equation 13 provides the basis of many “dual-EGO” catalyst control and diagnostic systems, although in practice the estimated oxygen storage and release rate is biased by the measurement error Ex(gas) present in both the pre-catalyst and post-catalyst sensors. Under rich conditions, for example, the measured difference between pre- and post-catalyst AFR sensors can be expressed using Equations 9, 11, and 12 as:

$$\begin{matrix}( {Δλ}_{pre}^{′} - {Δλ}_{post}^{′} ) = \frac{1}{{\dot{n}}_{f} {K}_{λ}} \dot{θ} + ( {{ɛ}_{λ} ( gas )}_{pre} - {{ɛ}_{λ} ( gas )}_{post} ) \\ = \frac{1}{{\dot{n}}_{f} {K}_{λ}} \dot{θ} - \frac{0.5}{{K}_{λ}} ( {D}_{{H}_{2}} - \\ 1 ) ( {n}_{{H}_{2} pre} - {n}_{{H}_{2} post} )\end{matrix} \qquad ( Eqn . 14 )$$

The difference between pre- and post-catalyst sensors is therefore a measure not only of oxygen storage and release, but also of hydrogen generation or inhibition on the catalyst. If the latter is ignored, the bias that hydrogen generation or inhibition introduces will degrade the performance of the control or OBD strategy. Simple integration of Equation 14, for example, will not provide an accurate estimate of oxygen storage capacity (OSC), and this is perhaps one reason why reliable OSC diagnostics have been hard to implement in practice. If, however, the hydrogen-dependent term in Equation 14 is included in the analysis, then the existing EGO sensors can also act as hydrogen sensors, providing useful information about the reactions taking place on the catalyst brick.

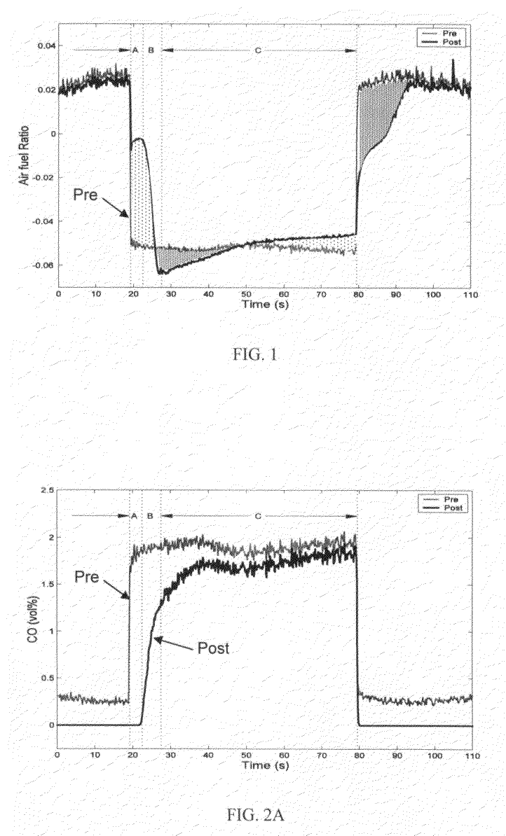

Consider for example the catalyst response to the lean-rich transition in feed gas (pre-catalyst) AFR shown in FIG. 1. If the hydrogen-dependent term in Equation 14 is ignored, then the lightly shaded areas between the two curves would correspond to periods of apparent oxygen release, and the more darkly shaded areas would signify periods of apparent oxygen storage. As seen from FIG. 1, such an interpretation would suggest that the catalyst can actually re-adsorb oxygen under rich conditions (as seen in the period when the post-catalyst AFR dips below the pre-catalyst value). It also suggests that the catalyst can continue to release oxygen almost indefinitely thereafter (as seen in the remaining period before the rich-lean transition occurs). Clearly this is not physically possible.

A more reasonable interpretation, which includes the effects of hydrogen, is as follows. During the initial period following the lean-rich transition (Zone A in FIG. 1), previously stored oxygen is released at a rate sufficient to fully oxidize the incoming feed gas; this results in a stoichiometric “plateau” in post-catalyst AFR and commensurately low levels of HC and CO emissions. As the store of oxygen becomes depleted, however, HC and CO breakthrough occurs and the post-catalyst AFR falls toward the pre-catalyst value (Zone B in FIG. 1). But the catalyst surface now has vacant sites, which promote oxidation of CO and HC through the water-gas shift and steam reforming reactions, respectively:

CO+H₂0→CO₂+H₂ (Eqn. 15)

CₓH_{y}+xH₂0→xCO+(x+y/2)H₂ (Eqn. 16)

Both of these reactions generate significant quantities of hydrogen post catalyst which, from Equation 12, causes the post-catalyst sensor to read richer than true. Indeed, as the true rate of oxygen release \dot{θ} tends to zero (towards the end of Zone B in FIG. 1), the difference between pre- and post-catalyst sensors becomes dominated by hydrogen effects, giving from Equation 14:

$${Δλ}_{post}^{′} = {Δλ}_{pre}^{′} + \frac{0.5}{{K}_{λ}} ( {D}_{{H}_{2}} - 1 ) ( {n}_{{H}_{2} pre} - {n}_{{H}_{2} post} ) \qquad ( Eqn . 17 )$$

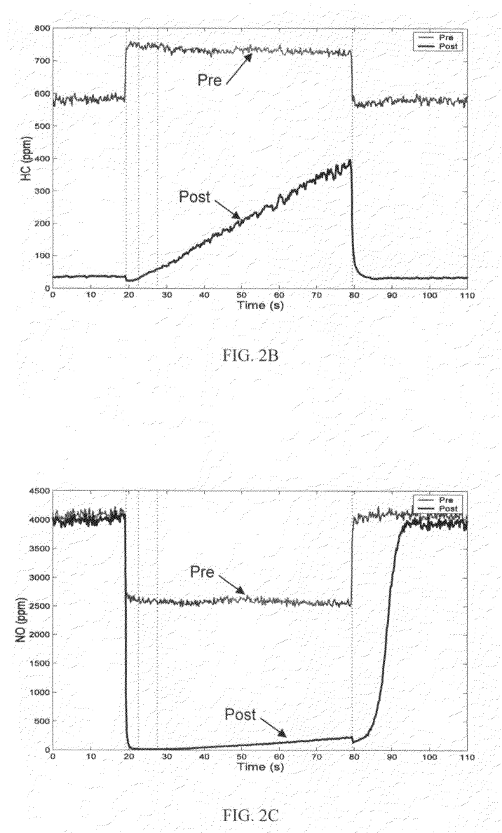

With plenty of vacant sites, the level of hydrogen generated by the catalyst initially exceeds the level in the feed gas, causing Δλ\dot{}′ₚₒₛₜ to dip below the pre-catalyst AFR as expected from Equation 17 and as seen in FIG. 1. By similar reasoning, the subsequent rise toward leaner values of post-catalyst AFR in Zone C of FIG. 1 suggests that the level of post-catalyst hydrogen slowly diminishes thereafter, corresponding to a progressive inhibition of the water-gas shift reaction, or a gradual deactivation of the catalyst surface. Further evidence of such deactivation can be seen in FIGS. 2A, 2B, and 2C, which show the post-catalyst response of the other gas components (CO, HC, and NO, respectively) in addition to the AFR response of FIG. 1. Levels of HC and NO in particular, having remained fairly low during the period of oxygen release (Zones A and B), are seen to rise significantly in Zone C, suggesting again that some form of deactivation is occurring. Indeed, the similarity of the AFR, HC, and NO responses is not surprising because all catalytic reactions are likely to be similarly affected by the activation state of the catalyst surface.

The importance of reversible catalyst deactivation dynamics in catalyst modeling and control has been discussed elsewhere. See, e.g., B. Cambell, R. Farrington, G. Inman, S. Dinsdale, D. Gregory, D. Eade, & J. Kisenyi, Improved Three-Way Catalyst Performance Using an Active Bias Control Regeneration System, SAE paper 2000-01-0499 (2000), and J. Peyton Jones, R. Jackson, & J. Roberts, The Importance Of Reversible Deactivation Dynamics For On-Board Catalyst Control And OBD Systems, SAE 2002 Transactions, Section 4: Journal of Fuels & Lubricants, pp. 76-84, also SAE paper 2002-01-0067 (2002). Its significance in the context of the present invention, however, is the evidence it provides that hydrogen generation and HC conversion efficiency are strongly correlated, and that the hydrogen-dependent term in Equation 17 can therefore be exploited as a measure of HC conversion efficiency under reversible deactivation conditions.

More formally, if one assumes,

n_{H2}_{ₚₒₛₜ}∝η_{HC} (Eqn. 18)

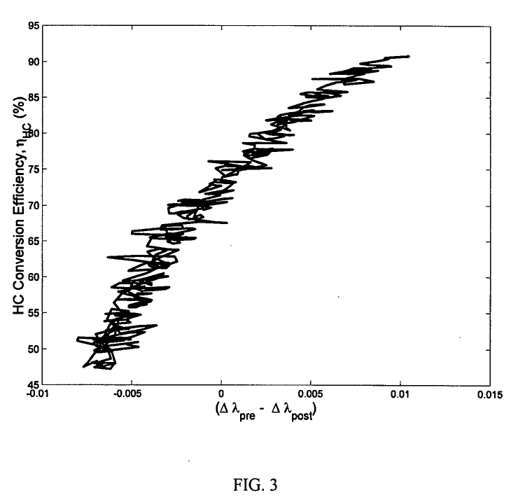

then Equation 14 can be re-written as:

$$( {Δλ}_{pre}^{′} - {Δλ}_{post}^{′} ) \approx \frac{1}{{\dot{n}}_{f} {K}_{λ}} \dot{θ} + {K}_{HC} {η}_{HC} + C \qquad ( Eqn . 19 )$$

where K_{HC} is a constant of proportionality and C is an offset dependent on the level of pre-catalyst H₂. Generally, Equation 19 is hard to apply under conditions of simultaneous oxygen release and surface deactivation because the two effects cannot be distinguished from each other. Once oxygen storage has been depleted, however, Equation 19 reduces to the equation of a straight line. To validate this relation, HC conversion efficiency was plotted against the difference between measured pre- and post-catalyst lambda for the reversible deactivation period (Zone C), as shown in FIG. 3. Although the results are not perfectly linear, they do support the contention that so called “distortion” of pre- and post-catalyst AFR sensor signals can be exploited as a measure of HC conversion efficiency and reversible catalyst deactivation. The question then remains whether the same process can be used as a measure of the more permanent catalyst deactivation caused by ageing.

### C. DUAL EGO SENSORS AND PERMANENT CATALYST DEACTIVATION

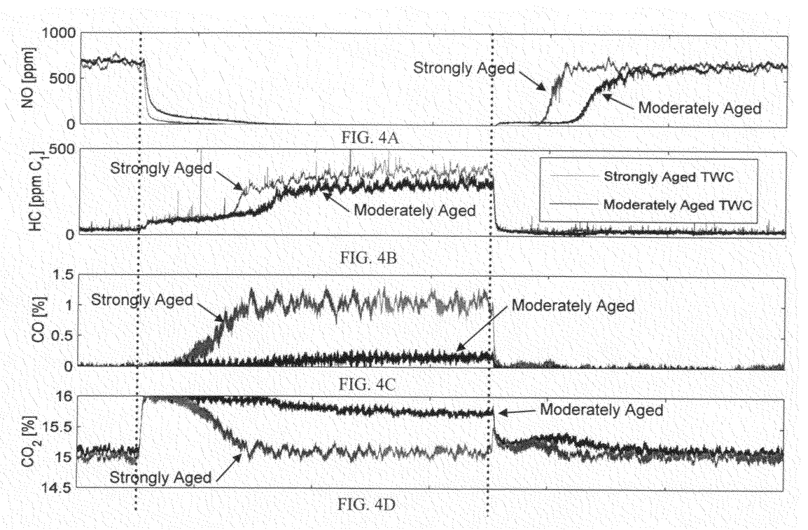

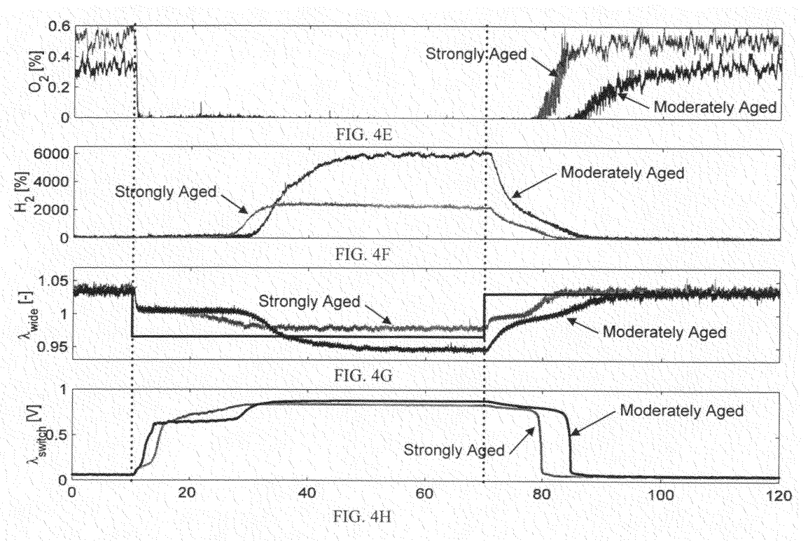

Data relevant to the relationship between EGO sensor response, hydrogen, HC conversion efficiency, and catalyst age have been previously published by T. Aukenthaler et al., Aspects of Dynamic Three-Way-Catalytic Converter Behaviour (mentioned above). Full experimental details are provided in that publication. As shown in FIGS. 4A, 4B, 4C, 4D, 4E, 4F, 4G, and 4H, the data describe the response of two differently aged catalysts to ±3% step changes in feed gas (pre-catalyst) lambda. The response is broadly similar to that presented in FIGS. 2A, 2B, and 2C, only the time scale is much slower, presumably because the catalyst oxygen storage capacity is larger in this case. The effects of reversible catalyst deactivation (although just about observable in the strongly aged response) are also much less marked, partly due to the compressed vertical axes of the plots and partly due to differences in catalyst formulation. The relationship between sensor bias, hydrogen, and HC, however, can be seen even more clearly because a hydrogen measurement is included in the data set.

Consider first the response of the “moderately aged” catalyst following the lean-rich transition at time=10 seconds. Initial oxygen release by the catalyst oxidizes the rich incoming feed gas, giving the familiar stoichiometric plateau observed in the post-catalyst AFR response, low levels of emissions, and high levels of the combustion product CO₂. At time=30 seconds, however, when the oxygen release rate can no longer satisfy feed gas demand, post-catalyst AFR starts moving into the rich region. At the same time H₂ levels rise significantly, suggesting the catalyst starts actively promoting the water-gas shift reaction. Indeed, the fact that CO levels do not rise during this period, and that CO₂ levels remain high, also provides further evidence that CO is being oxidized by the water-gas shift reaction. As expected, HC levels also rise significantly in this period, reflecting the growing oxygen deficiency. By about time=45 seconds, the catalyst is fully depleted of oxygen, and to a first approximation the system reaches steady state. The post-catalyst UEGO signal settles at a level below the pre-catalyst AFR. From Equation 17, this indicates that the catalyst is promoting the water-gas-shift reaction more strongly than say the data in FIGS. 2A, 2B, and 2C, and that the catalyst is still fairly active despite its “moderate” age.

The behavior of the “strongly aged” catalyst follows a similar pattern, only the response occurs on a shorter time scale due to the reduced oxygen storage capacity available. As might be expected, the level of HC is higher compared to the moderately aged case, and the degree to which the water-gas shift reaction is promoted is much lower (as evidenced by significantly lower levels of H₂ and CO₂, and higher levels of CO). Although such measurements are unlikely to be available for practical on-board diagnosis, these changes are also reflected in the post-catalyst UEGO signal which now settles at a level leaner than its pre-catalyst counterpart due to the reduced level of hydrogen present. Similar shifts can also be observed in FIG. 4H, both in the steady-state post-catalyst HEGO sensor response, and in the time at which this HEGO sensor switches its output from low to high voltage or vice versa. Although it is hard to draw rigorous conclusions from the two data points afforded by the two differently aged catalysts, the trend certainly supports the concept that Equation 19 holds as the catalyst ages, and that the steady state difference between pre- and post-catalyst sensors can be used as a new and effective metric for OBD monitoring of HC conversion efficiency.

### D. CONCLUSION

Although catalyst malfunction is defined in terms of HC emissions, conventional OBD strategies are typically based on some form of oxygen storage capacity metric. The performance of such systems is limited partly by the relatively weak correlation between these two variables, and partly by difficulties in estimating oxygen storage capacity from upstream and downstream EGO sensors. As shown above, these difficulties arise because EGO sensors respond not only to oxygen excess or deficiency, but also to hydrogen (under rich conditions) and NO₂ (under lean conditions). Changes in hydrogen concentration due to the reactions taking place on the catalyst brick are therefore indistinguishable from genuine oxygen storage and release effects, and will therefore bias the resulting oxygen storage capacity estimate.

Once the oxygen release rate has decayed to zero, however, any differences between pre- and post-catalyst sensors are due to differences in hydrogen concentration alone, i.e., the sensor becomes a hydrogen sensor. Although hydrogen is not itself a pollutant, transient changes in hydrogen generation due to reversible catalyst deactivation are strongly correlated to changes in HC conversion efficiency, and EGO sensor “distortion” can be exploited for diagnostic purposes. This conclusion is reinforced by the data presented above, where the degradation with age of both hydrogen generation and HC conversion efficiency is clearly reflected in a shift of the (steady state) post-catalyst EGO sensor signal relative to its pre-catalyst counterpart.

The use of dual EGO sensors, not to measure oxygen storage capacity but rather to measure hydrogen generation efficiency, is a more direct way of monitoring the health of the catalyst surface. Although the method offers potential advantages over conventional oxygen storage based methods, it is a rather intrusive test, requiring the catalyst to be fully depleted of oxygen if hydrogen dependency is to be observed independently of oxygen storage and release effects. This drawback might be resolved by integrating the method with a model of oxygen storage dynamics as discussed in J. Peyton Jones and K. Muske, Model-based OBD, and K. Muske and J. Peyton Jones, Model-based Fault Detection. Another useful possibility is to combine both oxygen-storage based metrics with the “sensor distortion” metric.

One or more steps of the method of the present invention can further be embodied in the form of computer-implemented methods and apparatus for practicing such methods, for example, and can be embodied in the form of computer program code embodied in tangible media, such as floppy diskettes, fixed (hard) drives, CD ROM's, magnetic tape, fixed/integrated circuit devices, or any other computer-readable storage medium, such that when the computer program code is loaded into and executed by a computer, the computer becomes an apparatus for practicing the invention.

Although illustrated and described above with reference to certain specific embodiments and examples, the present invention is nevertheless not intended to be limited to the details shown. Rather, various modifications may be made in the details within the scope and range of equivalents of the claim and without departing from the spirit of the invention. It is expressly intended, for example, that all ranges broadly recited in this document include within their scope all narrower ranges which fall within the broader ranges.

What is claimed:

1. In a vehicle on-board diagnostic exhaust system including a catalyst, a pre-catalyst exhaust gas oxygen sensor, and a post-catalyst exhaust gas oxygen sensor, a method of monitoring the catalyst comprising:
measuring hydrogen generation by the catalyst; and
correlating changes in hydrogen generation to changes in hydrocarbon conversion efficiency,
thereby using hydrogen generation as a metric for on-board diagnostic monitoring of the catalyst.

2. The method of claim 1 wherein hydrogen generation by the catalyst is measured as a function of post-catalyst exhaust gas oxygen sensor distortion.

3. The method of claim 1 wherein the step of measuring hydrogen generation includes calculating the difference between air-fuel ratio, normalized with respect to stoichiometry, at the pre-catalyst exhaust gas oxygen sensor and at the post-catalyst exhaust gas oxygen sensor.

4. The method of claim 3 wherein the air-fuel ratio is rich.

5. The method of claim 1 wherein the sensors are narrow-band heated exhaust gas oxygen sensors.

6. The method of claim 1 wherein the sensors are wide-band universal exhaust gas oxygen sensors

7. The method of claim 1 wherein hydrogen generation by the catalyst is measured after the sensors have reached steady-state, and the catalyst is substantially free of oxygen, during the reversible catalyst deactivation period.

8. The method of claim 1 further comprising the step of integrating oxygen-storage based metrics.

9. In a vehicle on-board diagnostic exhaust system including a catalyst, a pre-catalyst exhaust gas oxygen sensor, and a post-catalyst exhaust gas oxygen sensor, a program storage device readable by a machine, tangibly embodying a program of instructions executable by the machine to perform the method steps for on-board diagnostic monitoring of the catalyst, the method steps comprising:
measuring hydrogen generation by the catalyst; and
correlating changes in hydrogen generation to changes in hydrocarbon conversion efficiency,
thereby using hydrogen generation as a metric for on-board diagnostic monitoring of the catalyst.

10. The method of claim 9 wherein:
the step of measuring hydrogen generation includes calculating the difference between air-fuel ratio, normalized with respect to stoichiometry, at the pre-catalyst exhaust gas oxygen sensor and at the post-catalyst exhaust gas oxygen sensor;
the air-fuel ratio is rich; and
hydrogen generation by the catalyst is measured after the sensors have reached steady-state, and the catalyst is substantially free of oxygen, during the reversible catalyst deactivation period.

11. In a vehicle on-board diagnostic exhaust system including a catalyst, a pre-catalyst exhaust gas oxygen sensor, and a post-catalyst exhaust gas oxygen sensor, a method of monitoring the catalyst comprising:
measuring nitrogen dioxide generation by the catalyst; and
correlating changes in nitrogen dioxide generation to changes in catalytic conversion efficiency,
thereby using nitrogen dioxide generation as a metric for on-board diagnostic monitoring of the catalyst.

12. The method of claim 11 wherein nitrogen dioxide generation by the catalyst is measured as a function of post-catalyst exhaust gas oxygen sensor distortion.

13. The method of claim 11 wherein the step of measuring nitrogen dioxide generation includes calculating the difference between air-fuel ratio, normalized with respect to stoichiometry, at the pre-catalyst exhaust gas oxygen sensor and at the post-catalyst exhaust gas oxygen sensor.

14. The method of claim 13 wherein the air-fuel ratio is lean.

15. The method of claim 11 wherein the sensors are narrow-band heated exhaust gas oxygen sensors.

16. The method of claim 11 wherein the sensors are wide-band universal exhaust gas oxygen sensors

17. The method of claim 11 wherein nitrogen dioxide generation by the catalyst is measured after the sensors have reached steady-state, and the catalyst is substantially free of oxygen, during the reversible catalyst deactivation period.

18. The method of claim 11 further comprising the step of integrating oxygen-storage based metrics.

19. In a vehicle on-board diagnostic exhaust system including a catalyst, a pre-catalyst exhaust gas oxygen sensor, and a post-catalyst exhaust gas oxygen sensor, a program storage device readable by a machine, tangibly embodying a program of instructions executable by the machine to perform the method steps for on-board diagnostic monitoring of the catalyst, the method steps comprising:
measuring nitrogen dioxide generation by the catalyst; and
correlating changes in nitrogen dioxide generation to changes in catalytic conversion efficiency,
thereby using nitrogen dioxide generation as a metric for on-board diagnostic monitoring of the catalyst.

20. The method of claim 19 wherein:
the step of measuring nitrogen dioxide generation includes calculating the difference between air-fuel ratio, normalized with respect to stoichiometry, at the pre-catalyst exhaust gas oxygen sensor and at the post-catalyst exhaust gas oxygen sensor;
the air-fuel ratio is lean; and
nitrogen dioxide generation by the catalyst is measured after the sensors have reached steady-state, and the catalyst is substantially free of oxygen, during the reversible catalyst deactivation period.
